(19) United States
(12) Patent Application Publication
(10) Pub. No.: US 2018/0005136 A1
(43) Pub. Date: Jan. 4, 2018

(54) MACHINE LEARNING IN ADVERSARIAL ENVIRONMENTS

(71) Applicants: YI GAI, Hillsboro, OR (US); CHIH-YUAN YANG, Portland, OR (US); RAVI L. SAHITA, Beaverton, OR (US)

(72) Inventors: YI GAI, Hillsboro, OR (US); CHIH-YUAN YANG, Portland, OR (US); RAVI L. SAHITA, Beaverton, OR (US)

(21) Appl. No.: 15/201,224

(22) Filed: Jul. 1, 2016

(51) Int. Cl. G06N 99/00; G06F 21/55

(52) U.S. Cl. CPC G06N 99/005; G06F 21/55

(57) ABSTRACT

An adversarial environment classifier training system includes feature extraction circuitry to identify a number of features associated with each sample included in an initial data set that includes a plurality of samples. The system further includes sample allocation circuitry to allocate at least a portion of the samples included in the initial data set to at least a training data set; machine-learning circuitry communicably coupled to the sample allocation circuitry, the machine-learning circuitry to: identify at least one set of compromiseable features for at least a portion of the initial data set; define a classifier loss function [l(xᵢ, yᵢ, w)] that includes: a feature vector (xᵢ) for each sample included in the initial data set; a label (yᵢ) for each sample included in the initial data set; and a weight vector (w) associated with the classifier; and determine the minmax of the classifier loss function (min_{w}maxᵢ l(xᵢ, yᵢ, w)).

### TECHNICAL FIELD

The present disclosure relates to machine learning and more specifically to machine learning in adversarial environments.

### BACKGROUND

Cyber-attacks represent an increasing threat for most computer systems. Machine-learning systems provide relatively sophisticated and powerful tools for guarding against such cyber-attacks. General-purpose machine learning tools have witnessed success in automatic malware analysis. However, such machine learning tools may be vulnerable to attacks directed against the learning process employed to train the machines to detect the malware. For example, an adversary may “salt” or otherwise taint the training data set with training examples containing bits of malware such that the trained on-line system erroneously identifies future malware attacks as legitimate activity based on the salted or tainted training data set. The attacker's ability to exploit specific vulnerabilities of learning algorithms and carefully manipulate the training data set compromises the entire machine learning system. The use of salted or tainted training data may result in differences between the training data sets and any subsequent test data sets.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 depicts an illustrative machine-learning system that includes feature hashing circuitry, sample allocation circuitry, and machine learning circuitry, in accordance with at least one embodiment of the present disclosure;

FIG. 2 provides a block diagram of an illustrative system on which the machine learning circuitry and the adversarial-resistant classifier may be implemented, in accordance with at least one embodiment of the present disclosure; and

FIG. 3 provides a high level logic flow diagram of an illustrative method for training an adversarial environment classifier using machine learning in a potentially adversarial environment, in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

The systems and methods described herein provide improved system security and performance by minimizing the effects of salted or tainted training data used to train an adversarial environment classifier system via machine learning. From a game theory perspective, an adversarial environment classifier system should successfully anticipate the efforts of the malware generators at inserting malevolent code into the system. Such adversarial environment classifier systems may be designed around a minmax formulation. The minmax is a decision rule used in decision theory and game theory for minimizing the possible loss for a worst case scenario. In game theory, the minmax value is the smallest value that other players can force a player to receive without knowing the player's actions. Equivalently, it is the largest value that a player can be certain to receive when the player knows the actions of the other players.

In the systems and methods disclosed herein, when a feature is compromised by an adversary, the accuracy of the classifier is compromised. In other words, the supply of altered, “salted,” or tainted training data to an adversarial environment classifier machine learning system compromises the subsequent accuracy of the adversarial environment classifier. The systems and methods described herein minimize the worst case loss over all possible compromised features. Such systems and methods improve the performance of the adversarial environment classifier by providing a reduced overall error rate and a more robust defense to adversaries.

The systems and methods described herein take into consideration the worst-case loss of classification accuracy when a set of features are compromised by adversaries. The systems and methods disclosed herein minimize the impact of adversarial evasion when known solutions may otherwise fail. The systems and methods described herein result in a classifier that optimizes the worst case scenario in an adversarial environment when a set of features are compromised by attackers. Metadata may be used to define a maximum number of features that can be possibly compromised. A single bit may be used to permit the system designer to turn switch the adversarial mode ON and OFF. When the adversarial resistant mode is ON, the performance of the adversarial-resistant classifier is optimized to the worst-case accuracy loss. When the adversarial resistant mode is OFF, the adversarial-resistant classifier functions as a traditional classifier.

An adversarial environment classifier training system is provided. The adversarial environment classifier training system may include: feature extraction circuitry to identify a number of features associated with each sample included in an initial data set that includes a plurality of samples; sample allocation circuitry to allocate at least a portion of the samples included in the initial data set to at least a training data set; machine-learning circuitry communicably coupled to the sample allocation circuitry, the machine-learning circuitry to: identify at least one set of compromiseable features for at least a portion of the sample included in the initial data set; define a classifier loss function [l(xᵢ, yᵢ, w)] that includes: a feature vector (xᵢ) for each sample included in the initial data set; a label (yᵢ) for each sample included in the initial data set; and a weight vector (w) associated with the classifier; and determine the minmax of the classifier loss function (minₓmaxᵢ l(xᵢ, yᵢ, w)).

An adversarial environment classifier training method is provided. The method may include: allocating at least a portion of a plurality of samples included in an initial data set to at least a training data set; identifying a number of features associated with each sample included in an training data set; identifying at least one set of compromiseable features for at least a portion of the samples included in the training data set; defining a classifier loss function [l(xᵢ, yᵢ, w)] that includes: a feature vector (xᵢ) for each element included in the training data set; a label (yᵢ) for each element included in the training data set; and a weight vector (w) associated with the classifier; and determining the minmax of the classifier loss function (min_{w}maxᵢ l(xᵢ, yᵢ, w)).

A storage device that includes machine-readable instructions that, when executed, physically transform a configurable circuit to an adversarial environment classifier training circuit, the adversarial environment classifier training circuit to identify a number of features associated with each sample included in an initial data set that includes a plurality of samples; allocate at least a portion of the samples included in the initial data set to at least a training data set; identify at least one set of compromiseable features for at least a portion of the samples included in the training data set; define a classifier loss function [l(xᵢ, yᵢ, w)] that includes: a feature vector (xᵢ) for each sample included in the training data set; a label (yᵢ) for each sample included in the training data set; and a weight vector (w) associated with the classifier; and determine the minmax of the classifier loss function (min_{w}maxᵢ l(xᵢ, yᵢ, w)).

An adversarial environment classifier training system is provided. The adversarial environment classifier training system may include: means for identifying a number of features associated with each sample included in an initial data set that includes a plurality of samples; a means for allocating at least a portion of the samples included in the initial data set to at least a training data set; a means for identifying at least one set of compromiseable features for at least a portion of the samples included in the training data set; a means for defining a classifier loss function [l(xᵢ, yᵢ, w)] that includes: a feature vector (xᵢ) for each sample included in the training data set; a label (yᵢ) for each sample included in the training data set; and a weight vector (w) associated with the classifier; and a means for determining the minmax of the classifier loss function (min_{w}maxᵢ l(xᵢ, yᵢ, w)).

As used herein, the terms “top,” “bottom,” “up,” “down,” “upward,” “downward,” “upwardly,” “downwardly” and similar directional terms should be understood in their relative and not absolute sense. Thus, a component described as being “upwardly displaced” may be considered “laterally displaced” if the device carrying the component is rotated 90 degrees and may be considered “downwardly displaced” if the device carrying the component is inverted. Such implementations should be considered as included within the scope of the present disclosure.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

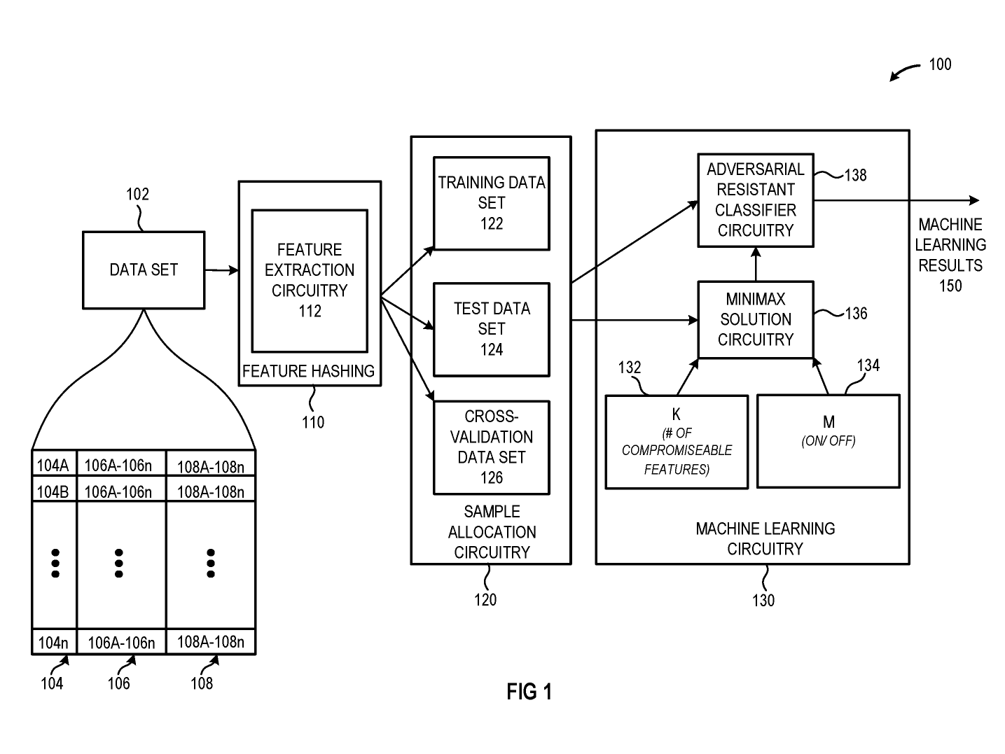

FIG. 1 depicts an illustrative adversarial environment classifier machine-learning system 100 that includes feature hashing circuitry 110, sample allocation circuitry 120, and machine learning circuitry 130, in accordance with at least one embodiment of the present disclosure. Feature extraction circuitry 112 may form or include a portion of the feature hashing circuitry 110 receives an initial data set 102 that includes a plurality of samples 104A-104n (collectively, “samples 104”). The feature hashing circuitry 110 may include feature extraction circuitry 112. The sample allocation circuitry 120 may allocate the data set received from the feature extraction circuitry 112 into one or more training data sets 122, one or more testing data sets 124, and one or more cross validation data sets 126. The machine learning circuitry 130 includes minmax solution circuitry 136 and adversarial resistant classifier circuitry 138. The machine learning circuitry provides at least the machine learning results 150 as an output. In embodiments, the initial data set 102 may be sourced from any number of locations. For example, the training data may be provided in the form of API log files from a McAfee Advance Threat Detect (ATD) box or a CF log from McAfee Chimera (Intel Corp., Santa Clara, Calif.).

Each of the samples 104 included in the initial data set 102 may have a respective number of features 106A-106n (collectively, “features 106”) logically associated therewith. A number of these features 106 may be manually or autonomously identified as potentially compromiseable features 108A-108n (collectively “compromiseable features 108”). Such compromiseable features 108 represent those features having the potential to be compromised by an adversarial agent. The variable “K” may be used to represent the maximum number of such compromiseable features 108 present in the initial data set 102.

The feature extraction circuitry 112 generates a data set that includes a respective feature vector (xᵢ for samples i=1 . . . n, where xᵢ εR^{d}, i=1, 2, . . . n) and a label (yᵢ for samples i=1 . . . n) logically associated with each sample included in the initial data set 102. The feature extraction circuitry 112 may include any number and/or combination of electrical components and/or semiconductor devices capable of forming or otherwise providing one or more logical devices, state machines, processors, and/or controllers capable of identifying and/or extracting one or more features 106A-106n logically associated with each of the samples 104. Any current or future developed feature extraction techniques may be implemented in the feature extraction circuitry.

In some implementations, one or more filter feature selection methods, such as the Chi squared test, information gain, and correlation scores may be employed by the feature extraction circuitry 112 to identify at least some of the features 106 present in the initial data set 102. Such filter feature selection methods may employ one or more statistical measures to apply or otherwise assign a scoring to each feature. Features may then be ranked by score and, based at least in part on the score, selected for inclusion in the data set or rejected for inclusion in the data set.

In some implementations, one or more wrapper methods, such as the recursive feature elimination selection method, may be employed by the feature extraction circuitry 112 to identify at least some of the features 106 present in the initial data set 102. Such wrapper feature selection methods consider the selection of a set of features as a search problem where different feature combinations are prepared, evaluated, and compared to other combinations.

In some implementations, one or more embedded feature selection methods, such as the LASSO method, the elastic net method, or the ridge regression method may be employed by the feature extraction circuitry 112 to identify at least some of the features 106 present in the initial data set 102. Such embedded feature selection methods may learn which features 106 best contribute to the accuracy of the classifier while the classifier is being created.

The sample allocation circuitry 120 receives the data set from the feature extraction circuitry 112 and allocates the contents of the received data set into one or more of: a training data set 122, a test data set 124, and a cross-validation data set 126. The sample allocation circuitry 120 may include any number and/or combination of electrical components and/or semiconductor devices capable of forming or otherwise providing one or more logical devices, state machines, processors, and/or controllers capable of allocating the samples 104 included in the initial data set 102 into a number of subsets. For example, as depicted in FIG. 1, the samples 104 may be allocated into one or more training data subsets 122, one or more testing data subsets 124, and/or one or more cross-validation subsets 126. In some implementations, the sample allocation circuitry 120 may randomly allocate the samples among some or all of the one or more training data subsets 122, the one or more testing data subsets 124, and/or the one or more cross-validation subsets 126. In some implementations, the sample allocation circuitry 120 may evenly or unevenly allocate the samples among some or all of the one or more training data subsets 122, the one or more testing data subsets 124, and/or the one or more cross-validation subsets 126.

The training data set 122 may be supplied to the minmax solution circuitry 136 which forms all or a portion of the machine learning circuitry 130. The minmax solution circuitry 136 may include any number and/or combination of electrical components and/or semiconductor devices that can form or otherwise provide one or more logical devices, state machines, processors, and/or controllers capable of solving a minmax problem. A minmax problem may include any problem in which a portion of the problem is minimized (e.g., the risk of loss attributable to acceptance of malicious code such as malware) over an entire sample population. The worst-case scenario exists when the maximum number of features have been salted, tainted, or otherwise corrupted (i.e., when “K” is maximized). For example, as depicted in FIG. 1, the minmax solution circuitry 136 may provide a solution for the following minmax problem:

min_{w}maxᵢl(xᵢ,yᵢ,w) (1)
where: w=weight vector of the classifier, wεR^{d}
l(xᵢ, yᵢ, w)=the loss function defined by the classifier
   In such an implementation, the loss function l(xᵢ, yᵢ, w) is minimized to produce, generate, or otherwise provide the adversarial resistant classifier circuitry 138 when the adversarial resistant classifier bit 134 (“M”) is set to a defined binary logic state. For example, when classifier bit 134 is in logical OFF state, the classifier circuitry 138 functions in a conventional, non-adversarial, mode. When classifier bit 134 is in a logical ON state, the classifier circuitry 138 functions in an adversarial resistant mode.

A support vector machine (SVM) may be used to provide an illustrative example of the implementation of the adversary resistant machine systems and methods described herein. Support vector machines are supervised learning models with associated learning algorithms that analyze data used for classification and regression analysis. Given a training data set 122 containing a number of samples 104, with each sample marked as a member of a valid sample subset or a malware sample subset, the SVM training algorithm assembles or otherwise constructs a model that determines whether subsequent samples 104 are valid or malware. Such an SVM may be considered to provide a non-probabilistic binary linear classifier. An SVM model is a representation of the samples 104 as points in space, mapped so that the examples of the separate categories are divided by a clear gap that is as wide as possible. New samples 104 are then mapped into that same space and predicted as being either valid or malware depending on the side of the gap the sample falls upon. The goal of SVM is to minimize the hinge loss given by the following equation:

$$min [ \frac{1}{2} {‖ w ‖}^{2} + C {\sum }_{i} [ 1 - {y}_{i} w \cdot {x}_{i} ] ] \qquad ( 2 )$$

When K features are compromised (i.e., the “worst case” scenario), the hinge loss for sample “i” is given by the following equation:

max[1−yᵢw·(xᵢ,*(1−aᵢ))] (3)
where: aᵢε{0,1}^{d}
   Σⱼaᵢⱼ=K

The maximization problem provided in equation (3) demonstrates the worst-case loss for sample i. To obtain a robust classifier, the worst-case loss over all samples should be minimized, forming a minmax problem. Thus, an adversarial resistant classifier may be obtained by solving the following problem:

min_{w}maxₐ_{₁}_{,a}_{₂}_{, . . . a}_{ₙ}1/2∥w∥²+CΣᵢ[1−yᵢw·(xᵢ,*(1−aᵢ))] (4)

The minmax problem presented in equation (4) may be solved directly by varying all possible scenarios. An alternative solution method that is more efficient is to convert the minmax problem into a quadratic program with convex duality transformations such that one or more fast algorithms may be applied. In some implementations, the value of “K” may be predetermined and solving the minmax problem for a fixed “K” value generates a classification model having greater resiliency to malignant data than a conventional classifier. In another embodiment, the value of “K” may be varied for at least some scenarios and the minmax problem solved for each scenario to determine an optimal “K” value.

Beneficially, solving the minmax problem improves the operation and performance of the host system by streamlining and improving the accuracy of detection of malignant code, particularly when training data may contain salted, tainted, or otherwise improperly amended code. By streamlining and improving the accuracy of malignant code detection, it is possible to reduce computing resources allocated to system security, freeing the resources for value-added processing capabilities. In embodiments, the one or more test data sets 124 and/or the one or more cross-validation data sets 126 may be provided to the adversarial resistant classifier 138 to test and/or validate system performance.

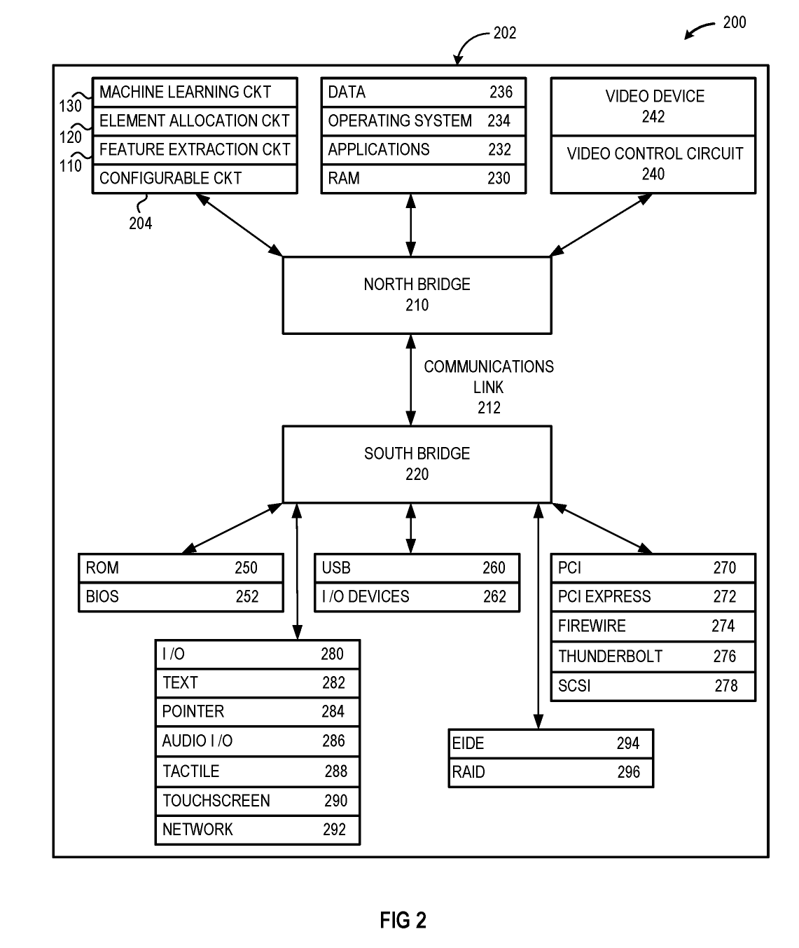

FIG. 2 provides a block diagram of an illustrative adversarial environment classifier system 200 in which the machine learning circuitry 130 and the adversarial-resistant classifier 138 may be implemented, in accordance with at least one embodiment of the present disclosure. Although described in the context of a personal computer 202, the various components and functional blocks depicted in FIG. 2 may be implemented in whole or in part on a wide variety of platforms and using components such as those found in servers, workstations, laptop computing devices, portable computing devices, wearable computing devices, tablet computing devices, handheld computing devices, and similar single- or multi-core processor or microprocessor based devices.

The configurable circuit 204 may include any number and/or combination of electronic components and/or semiconductor devices. The configurable circuit 204 may be hardwired in part or in whole. The configurable circuit 204 may include any number and/or combination of logic processing unit capable of reading and/or executing machine-readable instruction sets, such as one or more central processing units (CPUs), microprocessors, digital signal processors (DSPs), graphical processors/processing units (GPUs), application-specific integrated circuits (ASICs), field programmable gate arrays (FPGAs), etc. Unless described otherwise, the construction and operation of the various blocks shown in FIG. 2 are of conventional design. As a result, such blocks need not be described in further detail herein, as they will be readily understood by those skilled in the relevant art.

The general architecture of the illustrative system depicted in FIG. 2 includes a Northbridge 210 communicably coupled to a Southbridge 220. The Northbridge 210 may be communicably coupled to the configurable circuit, one or more nontransitory memories, and one or more video output devices, processing units, and/or controllers. The Southbridge 220 may be communicably coupled to nontransitory memory, one or more serial and/or parallel input/output bus structures, and any number of input/output devices.

The one or more configurable circuits 204 may include any number and/or combination of systems and/or devices capable of forming a circuit or multiple circuits that are able to execute one or more machine-readable instruction sets. In embodiments, the one or more configurable circuits 204 may include, but are not limited to, one or more of the following: hardwired electrical components and/or semiconductor devices; programmable gate arrays (PGA); reduced instruction set computers (RISC); digital signal processors; single- or multi-core processors; single- or multi-core microprocessors; application specific integrated circuits (ASIC); systems-on-a-chip (SoC); digital signal processors (DSP); graphical processing units (GPU); or any combination thereof. The one or more configurable circuits 204 may include processors or microprocessors capable of multi-thread operation.

In some implementations, the one or more configurable circuits 204 may execute one or more machine-readable instruction sets that cause all or a portion of the one or more configurable circuits 204 to provide the feature extraction circuitry 110, the sample allocation circuitry 120, and the machine learning circuitry 130. The one or more configurable circuits 204 may communicate with the Northbridge (and other system components) via one or more buses.

System memory may be communicably coupled to the Northbridge 210. Such system memory may include any number and/or combination of any current and/or future developed memory and/or storage devices. All or a portion of the system memory may be provided in the form of removable memory or storage devices that may be detached or otherwise decoupled from the system 200. In some implementations, system memory may include random access memory (RAM) 230. The RAM 230 may include electrostatic, electromagnetic, optical, molecular, and/or quantum memory in any number and/or combination. Information may be stored or otherwise retained in RAM 230 when the system 200 is in operation. Such information may include, but is not limited to one or more applications 232, an operating system 234, and/or program data 236. The system memory may exchange information and/or data with the configurable circuit 204 via the Northbridge 210.

In some implementations, the one or more applications 232 may include one or more feature extraction applications useful for identifying and/or extracting one or more features 106 from each of the samples 104 included in the initial data set 102. The one or more feature extraction applications may be executed by the configurable circuit 204 and/or the feature extraction circuitry 112. In some implementations, the one or more applications 232 may include one or more sample allocation applications useful for allocating the samples 102 included in the initial data set 102 into the one or more training data sets 122, the one or more test data sets 124, and/or the one or more cross-validation data sets 126. The one or more sample allocation applications may be executed by the configurable circuit 204 and/or the sample allocation circuitry 120. In some implementations, the one or more applications 232 may include one or more minmax problem solution applications. The one or more minmax problem solution applications may be executed by the configurable circuit 204, the machine learning circuitry 130, and/or the minmax solution circuitry 136.

The operating system 234 may include any current or future developed operating system. Examples of such operating systems 234 may include, but are not limited to, Windows® (Microsoft Corp, Redmond, Wash.); OSx (Apple Inc., Cupertino, Calif.); iOS (Apple Inc., Cupertino, Calif.); Android® (Google, Inc., Mountain View, Calif.); and similar. The operating system 234 may include one or more open source operating systems including, but not limited to, Linux, GNU, and similar.

The data 236 may include any information and/or data used, generated, or otherwise consumed by the feature hashing circuitry 110, the sample allocation circuitry 120, and/or the machine learning circuitry 130. The data 236 may include the initial data set 102, the one or more training data sets 122, the one or more test data sets 124, and/or the one or more cross-validation data sets 126.

One or more video control circuits 240 may be communicably coupled to the Northbridge 210 via one or more conductive members, such as one or more buses 215. In some implementations, the one or more video control circuits 240 may be communicably coupled to a socket (e.g., an AGP socket or similar) which, in turn, is communicably coupled to the Northbridge via the one or more buses 215. The one or more video control circuits 240 may include one or more stand-alone devices, for example one or more graphics processing units (GPU). The one or more video control circuits 240 may include one or more embedded devices, such as one or more graphics processing circuits disposed on a system-on-a-chip (SOC). The one or more video control circuits 240 may receive data from the configurable circuit 204 via the Northbridge 210.

One or more video output devices 242 may be communicably coupled to the one or more video control circuits. Such video output devices 242 may be wirelessly communicably coupled to the one or more video control circuits 240 or tethered (i.e., wired) to the one or more video control circuits 242. The one or more video output devices 242 may include, but are not limited to, one or more liquid crystal (LCD) displays; one or more light emitting diode (LED) displays; one or more polymer light emitting diode (PLED) displays; one or more organic light emitting diode (OLED) displays; one or more cathode ray tube (CRT) displays; or any combination thereof.

The Northbridge 210 and the Southbridge 220 may be communicably coupled via one or more conductive members, such as one or more buses 212 (e.g., a link channel or similar structure).

One or more read only memories (ROM) may be communicably coupled to the Southbridge 220 via one or more conductive members, such as one or more buses 222. In some implementations, a basic input/output system (BIOS) 252 may be stored in whole or in part within the ROM 250. The BIOS 252 may provide basic functionality to the system 200 and may be executed upon startup of the system 200.

A universal serial bus (USB) controller 260 may be communicably coupled to the Southbridge via one or more conductive members, such as one or more buses 224. The USB controller 260 provides a gateway for the attachment of a multitude of USB compatible I/O devices 262. Example input devices may include, but are not limited to, keyboards, mice, trackballs, touchpads, touchscreens, and similar. Example output devices may include printers, speakers, three-dimensional printers, audio output devices, video output devices, haptic output devices, or combinations thereof.

A number of communications interfaces may be communicably coupled to the Southbridge 220 via one or more conductive members, such as one or more buses 226. The communications and/or peripheral interfaces may include, but are not limited to, one or more peripheral component interconnect (PCI) interfaces 270; one or more PCI Express interfaces 272; one or more IEEE 1384 (Firewire) interfaces 274; one or more THUNDERBOLT® interfaces 276; one or more small computer serial (SCSI) interfaces 278; or combinations thereof.

A number of input/output (I/O) devices 280 may be communicably coupled to the Southbridge 220 via one or more conductive members, such as one or more buses 223. The I/O devices may include any number and/or combination of manual or autonomous I/O devices. For example, at least one of the I/O devices may be communicably coupled to one or more external devices that provide all or a portion of the initial data set 102. Such external devices may include, for example, a server or other communicably coupled system that collects, retains, or otherwise stores samples 104.

The I/O devices 280 may include one or more text input or entry (e.g., keyboard) devices 282; one or more pointing (e.g., mouse, trackball) devices 284; one or more audio input (e.g., microphone) and/or output (e.g., speaker) devices 286; one or more tactile output devices 288;

one or more touchscreen devices 290; one or more network interfaces 292; or combinations thereof. The one or more network interfaces 292 may include one or more wireless (e.g., IEEE 802.11, NFC, BLUETOOTH®, Zigbee) network interfaces, one or more wired (e.g., IEEE 802.3, Ethernet) interfaces; or combinations thereof.

A number of storage devices 294 may be communicably coupled to the Southbridge 220 via one or more conductive members, such as one or more buses 225. The one or more storage devices 294 may be communicably coupled to the Southbridge 220 using any current or future developed interface technology. For example, the storage devices 294 may be communicably coupled via one or more Integrated Drive Electronics (IDE) interfaces or one or more Enhanced IDE interfaces 296. In some implementations, the number of storage devices may include, but are not limited to an array of storage devices. One such example of a storage device array includes, but is not limited to, a redundant array of inexpensive disks (RAID) storage device array 298.

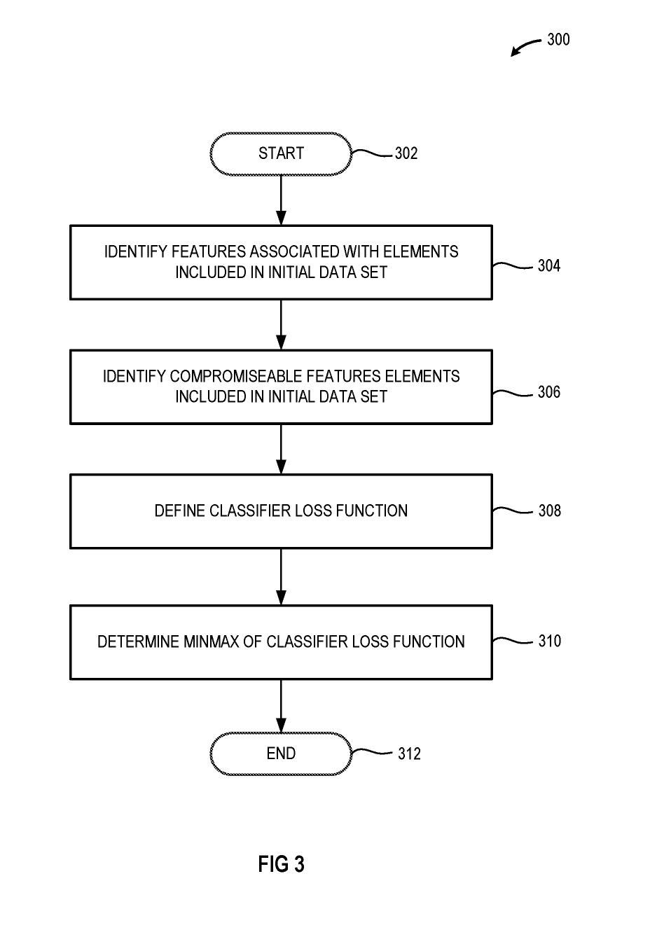

FIG. 3 provides a high level logic flow diagram of an illustrative method 300 for training a classifier using machine learning in a potentially adversarial environment, in accordance with at least one embodiment of the present disclosure. As discussed above, machine learning provides a valuable mechanism for training systems to identify and classify incoming code, data, and/or information as SAFE or as MALICIOUS. Machine learning systems rely upon accurate and trustworthy training data sets to properly identify incoming code, data, and/or information as SAFE and also to not misidentify incoming code, data, and/or information as MALICIOUS. It is possible to “salt” or otherwise taint the training data samples used to train the classifier such that the classifier misidentifies online or real-time samples containing malicious code as SAFE. Identifying compromiseable features included in the initial training data 102 and minimizing the potential for misclassification of such samples as SAFE thus improves the accuracy, efficiency, and safety of the classifier. The method 300 commences at 302.

At 304, the feature extraction circuitry 112 identifies features 106 logically associated with samples included in the initial data set 102. In some implementations, the initial data set 102 may be provided in whole or in part by one or more communicably coupled systems or devices. Any current or future developed feature extraction method may be employed or otherwise executed by the feature extraction circuitry 112 to identify features 106 logically associated with the samples 104 included in the initial data set 102.

At 306, potentially compromiseable features 108 logically associated with at least a portion of the samples 104 included in the initial data set 102 are identified. Potentially compromiseable features are those features 106 identified as being high risk of alteration and/or tainting in a manner that compromises system security. Such features 106 may, for example, represent features in which hard to detect or small changes may ease the subsequent classification of real-time samples containing surreptitiously inserted malware or other software, trojans, viruses, or combinations thereof as SAFE rather than MALICIOUS by the trained adversarial resistant classifier circuitry 138.

In some implementations, the feature extraction circuitry 112 may autonomously identify at least a portion of the potentially compromiseable features 108. In some implementations, at least a portion of the potentially compromiseable features 108 may be manually identified. In some implementations, the sample allocation circuitry 120 may autonomously identify at least a portion of the potentially compromiseable features 108 prior to allocating the samples 104 into the one or more training data sets 122, one or more test data sets 124, and/or one or more cross-validation data sets 126.

At 308, the classifier loss function is defined. The classifier loss function is a computationally possible function that represents the price paid for inaccuracy of predictions in classification problems (e.g., the Bayes error or the probability of misclassification). In at least some implementations, the classifier loss function may be defined by the following expression:

l(xᵢ,yᵢ,w) (5)
where w=weight vector of the classifier, wεR^{d}
xᵢ=feature vector for samples i=1 . . . n, where xᵢεR^{d}=1, 2, . . . n)

yᵢ=label for samples i=1 . . . n (e.g., SAFE/MALICIOUS)

Generally, the loss function will be given by the type of classifier used to perform the classification operation on the samples 104.

At 310, the minmax for the classifier loss function is determined by the minmax solution circuitry 136. The minmax solution circuitry 136 may autonomously solve the minmax logically associated with the adversarial resistant classifier circuitry 138 using one or more analytical techniques to assess the worst-case loss scenario for the respective adversarial resistant classifier circuitry 138 when the maximum number of potentially compromiseable features 108 have actually been compromised. In some implementations, this worst-case loss value may be compared to one or more defined threshold values to determine whether appropriate adversarial resistant classifier circuitry 138 has been selected. The method 300 concludes at 312.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

As described herein, various embodiments may be implemented using hardware elements, software elements, or any combination thereof. Examples of hardware elements may include processors, microprocessors, circuits, circuit elements (e.g., transistors, resistors, capacitors, inductors, coils, transmission lines, slow-wave transmission lines, transformers, and so forth), integrated circuits, application specific integrated circuits (ASIC), wireless receivers, transmitters, transceivers, smart antenna arrays for beamforming and electronic beam steering used for wireless broadband communication or radar sensors for autonomous driving or as gesture sensors replacing a keyboard device for tactile internet experience, screening sensors for security applications, medical sensors (cancer screening), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The following examples pertain to further embodiments. The following examples of the present disclosure may comprise subject material such devices, systems, methods, and means for providing a machine learning system suitable for use in adverse environments where training data may be compromised.

According to example 1, there is provided an adversarial machine-learning system. The adversarial machine learning system may include: feature extraction circuitry to identify a number of features associated with each sample included in an initial data set that includes a plurality of samples; sample allocation circuitry to allocate at least a portion of the samples included in the initial data set to at least a training data set; machine-learning circuitry communicably coupled to the sample allocation circuitry, the machine-learning circuitry to: identify at least one set of compromiseable features for at least a portion of the sample included in the initial data set; define a classifier loss function [l(xᵢ, yᵢ, w)] that includes: a feature vector (xᵢ) for each sample included in the initial data set; a label (yᵢ) for each sample included in the initial data set; and a weight vector (w) associated with the classifier; and determine the minmax of the classifier loss function (min_{w}maxᵢ l(xᵢ, yᵢ, w)).

Example 2 may include elements of example 1 where the sample allocation circuitry further comprises circuitry to allocate at least a portion of the samples included in the initial data set to at least one of: a training data set; a testing data set; or a cross-validation data set.

Example 3 may include elements of example 1 where machine-learning circuitry may autonomously identify at least one set of compromiseable features for at least a portion of the samples included in at least the training data set.

Example 4 may include elements of example 1 where the machine-learning circuitry may receive at least one input to manually identify at least one set of compromiseable features for at least a portion of the samples included in at least the training data set.

Example 5 may include elements of example 1 where the machine-learning circuitry may define a loss function that includes a first logical value for the label associated with an sample if the respective sample represents a non-malicious sample and may define a loss function that includes a second logical value for the label associated with an sample if the respective sample represents a malicious sample.

Example 6 may include elements of example 1 where the machine-learning circuitry may further identify a set consisting of a fixed number of compromiseable features for at least a portion of the samples included in at least the training data set.

Example 7 may include elements of example 1 where the machine-learning circuitry may further identify a plurality of sets of compromiseable features for at least a portion of the samples included in at least the training data set, each of the plurality of sets including a different number of compromiseable features for at least a portion of the samples included in the training data set.

According to example 8, there is provided a classifier training method. The method may include: allocating at least a portion of a plurality of samples included in an initial data set to at least a training data set; identifying a number of features associated with each sample included in an training data set; identifying at least one set of compromiseable features for at least a portion of the samples included in the training data set; defining a classifier loss function [l(xᵢ, yᵢ, w)] that includes: a feature vector (xᵢ) for each element included in the training data set; a label (yᵢ) for each element included in the training data set; and a weight vector (w) associated with the classifier; and determining the minmax of the classifier loss function (min_{w}maxᵢ l(xᵢ, yᵢ, w)).

Example 9 includes elements of example 8 where identifying at least one set of compromiseable features for at least a portion of the samples included in the training data set comprises: autonomously identifying at least one set of compromiseable features for at least a portion of the elements included in the training data set.

Example 10 may include elements of example 8 where identifying at least one set of compromiseable features for at least a portion of the samples included in the training data set may include manually identifying at least one set of compromiseable features for at least a portion of the samples included in the training data set.

Example 11 may include elements of example 8 where defining a classifier loss function [l(xᵢ, yᵢ, w)] that includes a label (yᵢ) for each sample included in the training data set may include defining a loss function that includes a first logical value for the label associated with an sample if the respective sample represents a non-malicious sample; and defining a loss function that includes a second logical value for the label associated with a sample if the respective sample represents a malicious sample.

Example 12 may include elements of example 8 where identifying at least one set of compromiseable features for at least a portion of the samples included in the training data set may include identifying a set consisting of a fixed number of compromiseable features for at least a portion of the samples included in the training data set.

Example 13 may include elements of example 8 where identifying at least one set of compromiseable features for at least a portion of the elements included in the training data set may include identifying a plurality of sets of compromiseable features for at least a portion of the samples included in the training data set, each of the plurality of sets including a different number of compromiseable features for at least a portion of the samples included in the training data set.

According to example 14, there is provided a storage device that includes machine-readable instructions that, when executed, physically transform a configurable circuit to an adversarial machine-learning training circuit, the adversarial machine-learning training circuit to: identify a number of features associated with each sample included in an initial data set that includes a plurality of samples; allocate at least a portion of the samples included in the initial data set to at least a training data set; identify at least one set of compromiseable features for at least a portion of the samples included in the training data set; define a classifier loss function [l(xᵢ, yᵢ, w)] that includes: a feature vector (xᵢ) for each sample included in the training data set; a label (yᵢ) for each sample included in the training data set; and a weight vector (w) associated with the classifier; and determine the minmax of the classifier loss function (min_{w}maxᵢ l(xᵢ, yᵢ, w)).

Example 15 may include elements of example 14 where the machine-readable instructions that cause the adversarial machine-learning training circuit to identify at least one set of compromiseable features for at least a portion of the samples included in the training data set, cause the adversarial machine-learning training circuit to: autonomously identify at least one set of compromiseable features for at least a portion of the samples included in the training data set.

Example 16 may include elements of example 14 where the machine-readable instructions that cause the adversarial machine-learning training circuit to identify at least one set of compromiseable features for at least a portion of the samples included in the training data set, cause the adversarial machine-learning training circuit to receive an input that includes data that manually identifies at least one set of compromiseable features for at least a portion of the samples included in the training data set.

Example 17 may include elements of example 14 where the machine-readable instructions that cause the adversarial machine-learning training circuit to define a classifier loss function [l(xᵢ, yᵢ, w)] that includes a label (yᵢ) for each sample included in the training data set, further cause the adversarial machine-learning training circuit to: define a loss function that includes a first logical value for the label associated with an sample if the respective sample represents a non-malicious sample; and define a loss function that includes a second logical value for the label associated with a sample if the respective sample represents a malicious sample.

Example 18 may include elements of example 14 where the machine-readable instructions that cause the adversarial machine-learning training circuit to identify at least one set of compromiseable features for at least a portion of the samples included in the training data set, further cause the adversarial machine-learning training circuit to identify a set consisting of a fixed number of compromiseable features for at least a portion of the samples included in the training data set.

Example 19 may include elements of example 15 where the machine-readable instructions that cause the adversarial machine-learning training circuit to identify at least one set of compromiseable features for at least a portion of the samples included in the training data set, further cause the adversarial machine-learning training circuit to identify a plurality of sets of compromiseable features for at least a portion of the samples included in the training data set, each of the plurality of sets including a different number of compromiseable features for at least a portion of the samples included in the training data set.

According to example 20, there is provided an adversarial environment classifier training system. The adversarial environment classifier training system may include: a means for identifying a number of features associated with each sample included in an initial data set that includes a plurality of samples; a means for allocating at least a portion of the samples included in the initial data set to at least a training data set; a means for identifying at least one set of compromiseable features for at least a portion of the samples included in the training data set; a means for defining a classifier loss function [l(xᵢ, yᵢ, w)] that includes: a feature vector (xᵢ) for each sample included in the training data set; a label (yᵢ) for each sample included in the training data set; and a weight vector (w) associated with the classifier; and a means for determining the minmax of the classifier loss function (min_{w}maxᵢ l(xᵢ, yᵢ, w)).

Example 21 may include elements of example 20 where the means for identifying at least one set of compromiseable features for at least a portion of the samples included in the training data set comprises: a means for autonomously identifying at least one set of compromiseable features for at least a portion of the samples included in the training data set.

Example 22 may include elements of example 20 where the means for identifying at least one set of compromiseable features for at least a portion of the samples included in the training data set comprises: a means for manually identifying at least one set of compromiseable features for at least a portion of the samples included in the training data set.

Example 23 may include elements of example 20 where the means for defining a classifier loss function [l(xᵢ, yᵢ, w)] that includes a label (yᵢ) for each sample included in the training data set comprises a means for defining a loss function that includes a first logical value for the label associated with a sample if the respective sample represents a non-malicious sample; and a means for defining a loss function that includes a second logical value for the label associated with a sample if the respective sample represents a malicious sample.

Example 24 may include elements of example 20 where the means for identifying at least one set of compromiseable features for at least a portion of the samples included in the training data set comprises a means for identifying a set consisting of a fixed number of compromiseable features for at least a portion of the samples included in the training data set.

Example 25 may include elements of example 20 where identifying at least one set of compromiseable features for at least a portion of the samples included in the training data set comprises a means for identifying a plurality of sets of compromiseable features for at least a portion of the samples included in the training data set, each of the plurality of sets including a different number of compromiseable features for at least a portion of the samples included in the training data set.

According to example 26, there is provided a system for training an adversarial environment classifier, the system being arranged to perform the method of any of examples 8 through 13.

According to example 27, there is provided a chipset arranged to perform the method of any of examples 8 through 13.

According to example 28, there is provided at least one machine readable medium comprising a plurality of instructions that, in response to be being executed on a computing device, cause the computing device to carry out the method according to any of examples 8 through 13.

According to example 29, there is provided a device configured for training an adversarial environment classifier, the device being arranged to perform the method of any of the examples 8 through 13.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. An adversarial environment classifier training system, comprising:
feature extraction circuitry to identify a number of features associated with each sample included in an initial data set that includes a plurality of samples;
sample allocation circuitry to allocate at least a portion of the samples included in the initial data set to at least a training data set;
machine-learning circuitry communicably coupled to the sample allocation circuitry, the machine-learning circuitry to:
identify at least one set of compromiseable features for at least a portion of the samples included in the training data set;
define a classifier loss function [l(xᵢ, yᵢ, w)] that includes:
a feature vector (xᵢ) for each sample included in the training data set;
a label (yᵢ) for each sample included in the training data set; and
a weight vector (w) associated with the classifier; and
determine the minmax of the classifier loss function (min_{w}maxᵢ l(xᵢ, yᵢ, w)).

2. The system of claim 1 wherein the sample allocation circuitry further comprises circuitry to allocate at least a portion of the samples included in the initial data set to at least one of: a training data set; a testing data set; or a cross-validation data set.

3. The system of claim 1, the machine-learning circuitry to autonomously identify at least one set of compromiseable features for at least a portion of the samples included in the training data set.

4. The system of claim 1, the machine-learning circuitry to receive at least one input to manually identify at least one set of compromiseable features for at least a portion of the samples included in the training data set.

5. The system of claim 1, the machine-learning circuitry to:
define a loss function that includes a first logical value for the label associated with a sample if the respective sample represents a non-malicious sample; and
define a loss function that includes a second logical value for the label associated with a sample if the respective sample represents a malicious sample.

6. The system of claim 1, the machine-learning circuitry to further:
identify a set consisting of a fixed number of compromiseable features for at least a portion of the samples included in the training data set.

7. The system of claim 1, the machine-learning circuitry to further:
identify a plurality of sets of compromiseable features for at least a portion of the samples included in the training data set, each of the plurality of sets including a different number of compromiseable features for at least a portion of the samples included in the training data set.

8. A adversarial environment classifier training method, comprising:
identifying a number of features associated with each sample included in an initial data set that includes a plurality of samples;
allocating at least a portion of the samples included in the initial data set into at least a training data set;
identifying at least one set of compromiseable features for at least a portion of the samples included in the training data set;
defining a classifier loss function [l(xᵢ, yᵢ, w)] that includes:
a feature vector (xᵢ) for each sample included in the training data set;
a label (yᵢ) for each sample included in the training data set; and
a weight vector (w) associated with the classifier; and
determining the minmax of the classifier loss function (min_{w}maxᵢ l(xᵢ, yᵢ, w)).

9. The method of claim 8 wherein identifying at least one set of compromiseable features for at least a portion of the samples included in the training data set comprises:
autonomously identifying at least one set of compromiseable features for at least a portion of the samples included in the training data set.

10. The method of claim 8 wherein identifying at least one set of compromiseable features for at least a portion of the samples included in the training data set comprises:
manually identifying at least one set of compromiseable features for at least a portion of the samples included in the training data set.

11. The method of claim 8 wherein defining a classifier loss function [l(xᵢ, yᵢ, w)] that includes a label (yᵢ) for each sample included in the training data set comprises:
defining a loss function that includes a first logical value for the label associated with an sample if the respective sample represents a non-malicious sample; and
defining a loss function that includes a second logical value for the label associated with an sample if the respective sample represents a malicious sample.

12. The method of claim 8 wherein identifying at least one set of compromiseable features for at least a portion of the samples included in the training data set comprises:
identifying a set consisting of a fixed number of compromiseable features for at least a portion of the samples included in the training data set.

13. The method of claim 8 wherein identifying at least one set of compromiseable features for at least a portion of the samples included in the training data set comprises:
identifying a plurality of sets of compromiseable features for at least a portion of the samples included in the training data set, each of the plurality of sets including a different number of compromiseable features for at least a portion of the samples included in the training data set.

14. A storage device that includes machine-readable instructions that, when executed, physically transform a configurable circuit to an adversarial machine-learning training circuit, the adversarial environment classifier training circuit to:
identify a number of features associated with each sample included in a training data set that includes a plurality of samples;
allocate at least a portion of the samples included in the initial data set to at least a training data set;
identify at least one set of compromiseable features for at least a portion of the samples included in the training data set;
define a classifier loss function [l(xᵢ, yᵢ, w)] that includes:
a feature vector (xᵢ) for each sample included in the training data set;
a label (yᵢ) for each sample included in the training data set; and
a weight vector (w) associated with the classifier; and
determine the minmax of the classifier loss function (min_{w}maxᵢ l(xᵢ, yᵢ, w)).

15. The storage device of claim 14 wherein the machine-readable instructions that cause the adversarial environment classifier training circuit to identify at least one set of compromiseable features for at least a portion of the samples included in the training data set, cause the adversarial environment classifier training circuit to:
autonomously identify at least one set of compromiseable features for at least a portion of the samples included in the training data set.

16. The storage device of claim 14 wherein the machine-readable instructions that cause the adversarial environment classifier training circuit to identify at least one set of compromiseable features for at least a portion of the samples included in the training data set, cause the adversarial environment classifier training circuit to:
receive an input that includes data that manually identifies at least one set of compromiseable features for at least a portion of the samples included in the training data set.

17. The storage device of claim 14 wherein the machine-readable instructions that cause the adversarial environment classifier training circuit to define a classifier loss function [l(xᵢ, yᵢ, w)] that includes a label (yᵢ) for each sample included in the training data set, further cause the adversarial environment classifier training circuit to:
define a loss function that includes a first logical value for the label associated with an sample if the respective sample represents a non-malicious sample; and
define a loss function that includes a second logical value for the label associated with an sample if the respective sample represents a malicious sample.

18. The storage device of claim 14 wherein the machine-readable instructions that cause the adversarial environment classifier training circuit to identify at least one set of compromiseable features for at least a portion of the samples included in the training data set, further cause the adversarial environment classifier training circuit to:
identify a set consisting of a fixed number of compromiseable features for at least a portion of the samples included in the training data set.

19. The storage device of claim 14 wherein the machine-readable instructions that cause the adversarial environment classifier training circuit to identify at least one set of compromiseable features for at least a portion of the samples included in the training data set, further cause the adversarial environment classifier training circuit to:
identify a plurality of sets of compromiseable features for at least a portion of the samples included in the training data set, each of the plurality of sets including a different number of compromiseable features for at least a portion of the samples included in the training data set.

20. A classifier training system, comprising:
a means for identifying a number of features associated with each sample included in an initial data set that includes a plurality of samples;
a means for allocating at least a portion of the samples included in the initial data set into at least a training data set;
a means for identifying at least one set of compromiseable features for at least a portion of the samples included in the training data set;
a means for defining a classifier loss function [l(xᵢ, yᵢ, w)] that includes:
a feature vector (xᵢ) for each sample included in the training data set;
a label (yᵢ) for each sample included in the training data set; and
a weight vector (w) associated with the classifier; and
a means for determining the minmax of the classifier loss function (min_{w}maxᵢ l(xᵢ, yᵢ, w)).

21. The system of claim 20 wherein the means for identifying at least one set of compromiseable features for at least a portion of the samples included in the training data set comprises:
a means for autonomously identifying at least one set of compromiseable features for at least a portion of the samples included in the training data set.

22. The system of claim 20 wherein the means for identifying at least one set of compromiseable features for at least a portion of the samples included in the training data set comprises:
a means for manually identifying at least one set of compromiseable features for at least a portion of the samples included in the training data set.

23. The system of claim 20 wherein the means for defining a classifier loss function [l(xᵢ, yᵢ, w)] that includes a label (yᵢ) for each sample included in the training data set comprises:
a means for defining a loss function that includes a first logical value for the label associated with an sample if the respective sample represents a non-malicious sample; and
a means for defining a loss function that includes a second logical value for the label associated with an sample if the respective sample represents a malicious sample.

24. The system of claim 20 wherein the means for identifying at least one set of compromiseable features for at least a portion of the samples included in the training data set comprises:
a means for identifying a set consisting of a fixed number of compromiseable features for at least a portion of the samples included in the training data set.

25. The system of claim 20 wherein identifying at least one set of compromiseable features for at least a portion of the samples included in the training data set comprises:
a means for identifying a plurality of sets of compromiseable features for at least a portion of the samples included in the training data set, each of the plurality of sets including a different number of compromiseable features for at least a portion of the samples included in the training data set.
